(19) United States
(12) Patent Application Publication
(10) Pub. No.: US 2024/0210972 A1
(43) Pub. Date: Jun. 27, 2024

(54) DIGITAL CIRCUITRY AND POWER SUPPLY METHOD

(71) Applicant: SigmaStar Technology Ltd., Xiamen (CN)

(72) Inventors: Wei-Ping WANG, Taiwan (TW); Jyun-Jie YANG, Taiwan (TW)

(21) Appl. No.: 18/508,342

(22) Filed: Nov. 14, 2023

(30) Foreign Application Priority Data
Dec. 21, 2022 (CN) 202211650486.4

(51) Int. Cl. G05F 1/46

(52) U.S. Cl. CPC G05F 1/462

(57) ABSTRACT

A digital circuitry includes a reference voltage generator, a rail-to-rail low-dropout regulator and a logic circuit. The reference voltage generator generates a plurality of reference voltages. The rail-to-rail low-dropout regulator generates a plurality of control signals according to the reference voltages, and generates a plurality of driving voltages according to the control signals, wherein the driving voltages have the same variation tendency. The logic circuit operates in a voltage interval between the driving voltages.

This application claims the benefit of China application Serial No. CN202211650486.4, filed on Dec. 21, 2022, the subject matter of which is incorporated herein by reference.

### BACKGROUND OF THE INVENTION

### Field of the Invention

The present application relates to a digital circuitry, and more particularly to a digital circuitry having low power consumption and a power supply method thereof.

### Description of the Related Art

Dimensions of transistors continue to reduce as manufacturing processes advance, such that a leakage current in transistors is likely resulted in low-voltage operating environments, leading to unnecessary power consumption. In some prior art, an additional bias voltage is provided to the base of a transistor to adjust a threshold voltage of the transistor, thereby reducing the leakage current of the transistor. However, in such prior art, special processes or additional masks are needed to implement the bias voltage to the base, resulting in additional costs. In some other prior art, the length of transistors is increased to reduce the leakage current. However, the approach above fails to fully reduce the leakage current generated when a transistor operates in a sub-threshold region, similarly resulting in additional costs.

### SUMMARY OF THE INVENTION

In some embodiments, it is an object of the present application to provide a digital circuitry having low power consumption and a power supply method so as to improve the issues of the prior art.

In some embodiments, a digital circuitry includes a reference voltage generator, a rail-to-rail low-dropout regulator and a logic circuit. The reference voltage generator generates a plurality of reference voltages. The rail-to-rail low-dropout regulator generates a plurality of control signals according to the reference voltages, and generates a plurality of driving voltages according to the control signals, wherein the driving voltages have the same variation tendency. The logic circuit operates in a voltage interval between the driving voltages.

In some embodiments, a power supply method applicable to a digital circuitry includes the following operations: generating a plurality of reference voltages; generating a plurality of control signals according to the reference voltages, and generating a plurality of driving voltages according to the control signals, so as to supply power to a logic circuit of the digital circuitry, wherein the driving voltages have the same variation tendency.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a digital circuitry according to some embodiments of the present application;

FIG. 2 is a schematic diagram of a rail-to-rail low-dropout regulator in FIG. 1 according to some embodiments of the present application; and

FIG. 3 is a flowchart of a power supply method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuitry” may be a single system formed by one or more circuits, and the term “circuity” may be a device connected by at least one transistor and/or at least one active element by a predetermined means so as to process signals.

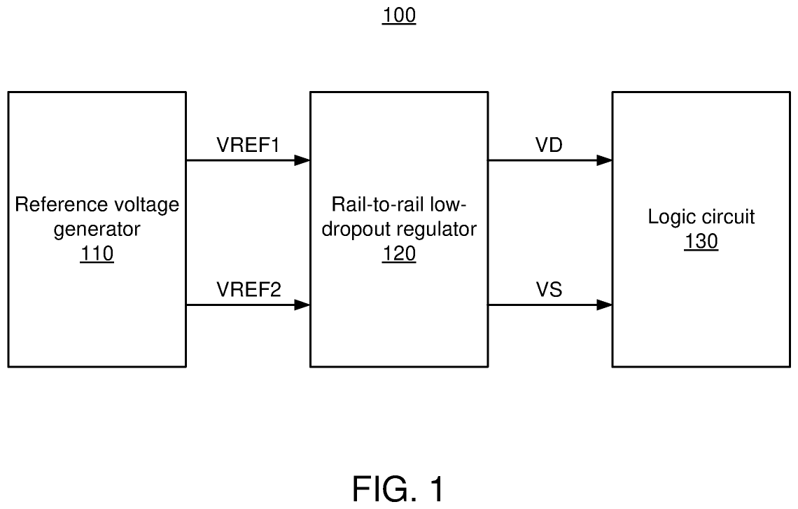

FIG. 1 shows a schematic diagram of a digital circuitry 100 according to some embodiments of the present application. The digital circuitry 100 includes a reference voltage generator 110, a rail-to-rail low-dropout regulator 120 and a logic circuit 130.

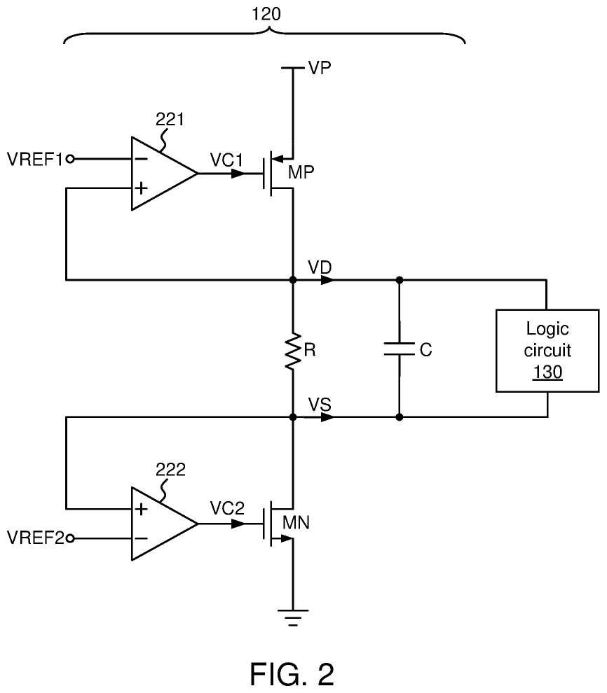

The reference voltage generator 110 generates a reference voltage VREF1 and a reference voltage VREF2. In some embodiments, the reference voltage generator 110 may be implemented by, for example but not limited to, a bandgap voltage reference circuit. The rail-to-rail low-dropout regulator 120 generates multiple control signals (for example, a control signal VC1 and a control signal VC2 in FIG. 2) according to the reference voltage VREF1 and the reference voltage VREF2, and generates a driving voltage VD and a driving voltage VS according to the control signals. In some embodiments, the driving voltage VD and the driving voltage VS have the same variation tendency. For example, when the driving voltage VS increases, the driving voltage VD also increases; or, when the driving voltage VS decrease, the driving voltage VD also decreases. Thus, a voltage difference between the driving voltage VD and the driving voltage VS can be kept to be within a predetermined range. In some embodiments, the driving voltage VD and the driving voltage VS can be used to supply power to the logic circuit 130. Thus, the logic circuit 130 is operable within the voltage interval between the driving voltage VD and the driving voltage VS.

In some embodiments, the logic circuit 130 may be a digital circuit that requires low power consumption. In some embodiments, the logic circuit 130 may be a circuit or a device primarily powered by a battery. For example, in some applications, the logic circuit 130 may be, for example but not limited to, a real-time clock (RTC) generator, which may be used to generate reference clocks used by other circuits. Since an RTC generator needs to operate continually, electric energy of a battery may be rapidly depleted if the power consumption of the RTC generator is too high. It should be noted that the type of the logic circuit 130 is an example and is not to be construed as a limitation to the present application.

In general, in order to implement applications having low power consumption, a leakage current of a transistor and dynamic power consumption of a circuit can be reduced. Ideally, when a transistor is turned off, the transistor does not generate any leakage current. Dimensions of transistors continue to reduce along with the advancement of processes, such that transistors may not be fully turned off when operating in a sub-threshold region in a low-voltage environment, leading to a leakage current. With reference to related publications, it is known that a threshold voltage of a transistor is positively correlated with a voltage difference between the source and the base of the transistor, and a leakage current generated when the transistor operates in a sub-threshold region is positively correlated with a voltage difference between the gate and the source and/or a voltage difference between the drain and the source of the transistor. Thus, the threshold voltage may be adjusted by reducing the source voltage of the transistor, so as to turn off the transistor as much as possible and at the same time reduce the leakage current generated by the transistor in the sub-threshold region. For example, under a condition when the base voltage is 0 V, as the source voltage gets higher, the threshold voltage of the transistor can be increased and the leakage current generated in the sub-threshold region can be reduced. In some embodiments of the present application, the driving voltage VS above can be used to adjust the source voltage of a transistor in the logic circuit 130 so as to adjust the threshold voltage of the transistor. Thus, the leakage current of the transistor can be reduced. In some embodiments, the driving voltage VD can be used as a high supply voltage (usually denoted as VDD) of the logic circuit 130, and the driving voltage VS can be used as a low supply voltage (usually denoted as VSS) of the logic circuit 130.

On the other hand, as described above, the driving voltage VD and the driving voltage VS have the same variation tendency. Thus, when the driving voltage VS varies, the driving voltage VD may have the same or similar variance, so as to ensure that the voltage difference between the driving voltage VD and the driving voltage VS is kept to be within a predetermined range, thereby ensuring that the logic circuit 130 has a sufficient voltage operation interval and a correct operation timing. Moreover, by means of setting the voltage difference between the driving voltage VD and the driving voltage VS, the voltage operation interval of the logic circuit 130 can be set, hence further adjusting the dynamic power consumption generated by the logic circuit 130.

In some embodiments, the logic circuit 130 may be implemented by one or more input/output (I/O) transistors. An I/O transistor usually has higher threshold characteristics and a lower gate leakage current. Thus, without increasing the length of a transistor or increasing the number of transistors, the leakage current can be further reduced to thereby better reduce power consumption. In some embodiments, the voltage received by the base of the transistor in the logic circuit 130 may be 0 V; however, the present application is not limited to the example above.

FIG. 2 shows a schematic diagram of the rail-to-rail low-dropout regulator in 120 FIG. 1 according to some embodiments of the present application. The rail-to-rail low-dropout regulator 120 includes an amplifier 221, an amplifier 222, a resistor R, a transistor MP and a transistor MN. The amplifier 221 and the amplifier 222 can generate the control signal VC1 and the control signal BC2 according to the reference voltage VREF1 and the reference voltage VREF2, respectively. More specifically, a negative input terminal of the amplifier 221 receives the reference voltage VREF1, a positive input terminal of the amplifier 221 receives the driving voltage VD, and an output terminal of the amplifier 221 outputs the control signal VC1. Thus, the amplifier 221 can generate the control signal VC1 according to the reference voltage VREF1 and the driving voltage VD. Similarly, a negative input terminal of the amplifier 222 receives the reference voltage VREF2, a positive input terminal of the amplifier 222 receives the driving voltage VS, and an output terminal of the amplifier 222 outputs the control signal VC2. Thus, the amplifier 222 can generate the control signal VC2 according to the reference voltage VREF2 and the driving voltage VS.

In this example, the transistor MP is a P-type transistor, and the transistor MN is an N-type transistor. A first terminal (for example, the source) of the transistor MP receives a power voltage VP, a second terminal (for example, the drain) of the transistor MP generates the driving voltage VD, and a control terminal (for example, the gate) of the transistor MP receives the control signal VC1. Thus, the transistor MP can be controlled by the control signal VC1 so as to generate the driving voltage VD. Similarly, a first terminal (for example, the drain) of the transistor MN is coupled to the second terminal of the transistor MP via the resistor R and generates the driving voltage VS, a second terminal (for example, the source) of the transistor MN is coupled to ground, and a control terminal (for example, the gate) of the transistor MN receives the control signal VC2. Thus, the transistor MN can be controlled by the control signal VC2 so as to generate the driving voltage VS.

In some embodiments, the amplifier 221 and the transistor MP can operate as a current-sourcing low-dropout regulator, which provides a current to the resistor R and the logic circuit 130. Similarly, in some embodiments, the amplifier 222 and the transistor MN can operate as a current-draining low-dropout regulator, which draws a current from the resistor R and the logic circuit 130. By coupling outputs (that is, the driving voltage VD and the driving voltage VS) of the two low-dropout regulators above in series via the resistor R, the driving voltage VD and the driving voltage VS can have the same variation tendency, thereby providing the voltage interval between the driving voltage VD and the driving voltage VS (equivalent to a voltage difference between the driving voltage VD and the driving voltage VS) with a more linear variation tendency. For example, if the level of the driving voltage VD is lowered due to process factors such as variances, voltage variances and/or temperature variances, the level of the driving voltage VS is also lowered on the basis of the serial coupling formed by using the resistor R. Or, if the level of the driving voltage VD rises due to the factors above, the level of the driving voltage VS also rises on the basis of the serial coupling formed via the resistor R. On the other hand, in the presence of any change in the amount of current used by the logic circuit 130, a negative feedback mechanism formed by the two low-dropout regulators above can correspondingly adjust the control signal VC1 and the control signal VC2, thereby enabling the driving voltage VD and the driving voltage VS to restore to stable levels. As such, in addition to reducing the leakage current of the logic circuit 130 by means of adjusting the driving voltage VS, it is ensured at the same time that the logic circuit 130 has a sufficient operable voltage interval.

In some embodiments, parameters such as the dimensions of the transistor MP, the dimensions of the transistor MN and/or the resistance value of the resistor R can be adjusted according to specifications and parameters such as a required current size of the logic circuit 130. In some embodiments, as shown in FIG. 2, the rail-to-rail low-dropout regulator 120 may further include a capacitor C. The capacitor C is coupled in series with the resistor R, so as to regulate the driving voltage VD and the driving voltage VS.

In some embodiments, the voltage interval between the driving voltage VD and the driving voltage VS can be approximately 0.8 V, and the operating speed (or a generated signal frequency) of the logic circuit 130 can be approximately 200 kHz. It should be noted that the above numerical values are merely examples, and the present application is not limited to these examples.

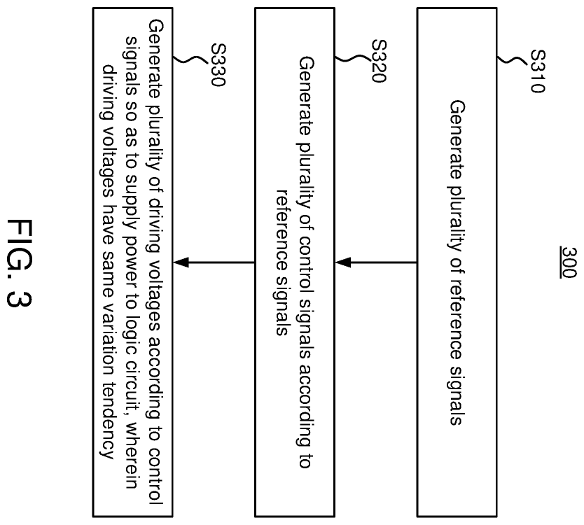

FIG. 3 shows a flowchart of a power supply method 300 according to some embodiments of the present application. In operation S310, a plurality of reference voltages (for example, the reference voltage VREF1 and the reference voltage VREF2 in FIG. 1 or FIG. 2) are generated. In operation S320, a plurality of control signals (for example, the control signal VC1 and the control signal VC2 in FIG. 2) are generated according to the reference signals. In operation S330, a plurality of driving voltages (for example, the driving voltage VD and the driving voltage VS in FIG. 1 or FIG. 2) are generated according to the control signals, so as to supply power to a logic circuit, wherein the driving voltages have the same variation tendency.

The details of the plurality of operations above may be referred from the description associated with the foregoing embodiments, and are omitted herein for brevity. The plurality operations of the power supply method 300 above are merely examples, and are not limited to being performed in the order specified in these examples. Without departing from the operation means and ranges of the various embodiments of the present application, additions, replacements, substitutions or omissions may be made to the operations of the power supply method 300, or the operations may be performed in different orders (for example, simultaneously performed or partially simultaneously performed).

In conclusion, by using a rail-to-rail low-dropout regulator, the digital circuitry and the power supply method according to some embodiments of the present application are capable of supplying power to a logic circuit that requires low power consumption. Thus, the threshold voltage of a transistor in the logic circuit can be adjusted and the leakage current can be reduced, and an operable voltage interval of the logic circuit can be set at the same time so as to set dynamic power consumption of the logic circuit, thereby satisfying requirements for lower power consumption.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A digital circuitry, comprising:
a reference voltage generator, generating a plurality of reference voltages;
a rail-to-rail low-dropout regulator, generating a plurality of control signals according to the reference voltages, and generating a plurality of driving voltages according to the control signals, wherein the driving voltages have the same variation tendency; and
a logic circuit, operating in a voltage interval between the driving voltages.

2. The digital circuitry according to claim 1, wherein the rail-to-rail low-dropout regulator comprises:
a plurality of amplifiers, generating a first control signal and a second control signal among the control signals according to the reference voltages;
a first transistor, controlled by the first control signal and generating a first driving voltage among the driving voltages;
a second transistor, controlled by the second control signal and generating a second driving voltage among the driving voltages; and
a resistor, coupled between the first transistor and the second transistor.

3. The digital circuitry according to claim 2, wherein the amplifiers comprise:
a first amplifier, generating the first control signal according to a first reference voltage among the reference voltages and the first driving voltage; and
a second amplifier, generating the second control signal according to a second reference voltage among the reference voltages and the second driving voltage.

4. The digital circuitry according to claim 2, wherein the rail-to-rail low-dropout regulator further comprises:
a capacitor, coupled in parallel to the resistor.

5. The digital circuitry according to claim 1, wherein one of the driving voltages is used to adjust a threshold voltage of a transistor in the logic circuit.

6. The digital circuitry according to claim 1, wherein the logic circuit is implemented by at least one input/output transistor.

7. The digital circuitry according to claim 1, wherein the logic circuit is a real-time clock (RTC) generator.

8. A power supply method, applied to a digital circuitry, the method comprising:
generating a plurality of reference voltages;
generating a plurality of control signals according to the reference voltages; and
generating a plurality of driving voltages according to the control signals, so as to supply power to a logic circuit of the digital circuitry, wherein the driving voltages have the same variation tendency.

9. The power supply method according to claim 8, wherein the generating of a plurality of control signals according to the reference voltages comprises:
generating a first control signal among the control signals according to a first reference voltage among the reference voltages and a first driving voltage among the driving voltages by a first amplifier; and
generating a second control signal among the control signals according to a second reference voltage among the reference voltages and a second driving voltage among the driving voltages by a second amplifier.

10. The power supply method according to claim 8, wherein the generating of a plurality of driving voltages comprises:
generating a first driving voltage among the driving voltages according to a first control signal among the control signals by a first transistor, and
generating a second driving voltage among the driving voltages according to a second control signal among the control signals by a second transistor, wherein the first transistor is coupled to the second transistor via a resistor.
